(19) United States
(12) Patent Application Publication
(10) Pub. No.: US 2023/0012343 A1
(43) Pub. Date: Jan. 12, 2023

(54) MOLECULAR WEIGHT MARKER FOR ELECTROPHORESIS, NUCLEIC ACID FRACTIONATION METHOD AND NUCLEIC ACID SIZE ANALYSIS METHOD

(71) Applicant: Hitachi High-Tech Corporation, Tokyo (JP)

(72) Inventors: Mima OGAWA, Tokyo (JP); Takahide YOKOI, Tokyo (JP)

(73) Assignee: Hitachi High-Tech Corporation, Tokyo (JP)

(21) Appl. No.: 17/782,194

(22) PCT Filed: Dec. 20, 2019
(86) PCT No.: PCT/JP2019/050152

§ 371 Date: Jun. 3, 2022

(51) Int. Cl. G01N 27/447

(52) U.S. Cl. CPC G01N 27/44726

(57) ABSTRACT

In order to provide a molecular weight marker for electrophoresis that can be simultaneously electrophoresed in a same lane as a sample and can accurately predict an electrophoresis position of the sample, the molecular weight marker for electrophoresis of the present disclosure is characterized by containing a polyelectrolyte that is negatively charged in an aqueous solution and does not serve as a template for a DNA polymerase reaction.

### TECHNICAL FIELD

The present disclosure relates to a molecular weight marker for electrophoresis, a nucleic acid fractionation method, and a nucleic acid size analysis method.

### BACKGROUND ART

The gel electrophoresis is a method for analyzing a biological substance such as a nucleic acid or a protein by utilizing a phenomenon that an electrically charged substance, when an electric field is applied thereto, moves in a direction toward an electrode having an opposite polarity. In general, electrophoresis gel such as an agarose gel or an acrylamide gel is used as a support of a biological substance. Since biological substances move in electrophoresis gel at different speeds depending on molecular weights thereof, the biological substances are separated as bands according to the molecular weights. Having high resolution relating to the separation of biological substances, the gel electrophoresis is also employed to separate and collect (fractionate) a biological substance having a target molecular weight from a biological substance having another molecular weight (PTLs 1 and 2).

Conventionally, in order to estimate a movement position of a target biological substance, a biological substance having a known size is used as a ladder marker. In general, in order to avoid contamination during electrophoresis, ladder markers are electrophoresed in parallel in adjacent lanes (PTL 3 and NPL 1).

### CITATION LIST

### Patent Literature

PTL 1: JP 2004-290109 A
PTL 2: JP 2010-502962 W
PTL 3: U.S. Pat. No. 9,719,961

### Non-Patent Literature

NPL 1: Sambrook, J. et al. Molecular Cloning: A Laboratory Manual. (CSHL Pr., 2001).

### SUMMARY OF INVENTION

### Technical Problem

However, it is widely recognized among practitioners in this field that different lanes of electrophoresis may cause different mobilities even for samples having the same molecular weight. Therefore, in the method of electrophoresing the ladder marker in the lane adjacent to the lane of the biological sample, as in PTL 3 and NPL 1, it may be difficult to accurately predict the position of the target biological sample.

In addition, the number of samples that can be processed by one operation of electrophoresis is reduced by the number of marker lanes, which leads to a problem in terms of throughput.

Therefore, the present disclosure provides a molecular weight marker for electrophoresis that can be simultaneously electrophoresed in the same lane as a sample and can accurately predict the electrophoresis position of the sample.

### Solution to Problem

In order to solve the above problems, a molecular weight marker for electrophoresis of the present disclosure contains a polyelectrolyte which is negatively charged in an aqueous solution and does not serve as a template for a DNA polymerase reaction.

Further features related to the present disclosure will become apparent from the description of the present specification and the accompanying drawings. Aspects of the present disclosure are achieved and realized by elements, combinations of various elements, and aspects of the following detailed description and appended claims.

The description of the present specification is merely exemplary, and does not limit the scope of claims or application examples of the present disclosure in any sense.

### Advantageous Effects of Invention

The molecular weight marker for electrophoresis of the present disclosure can be simultaneously electrophoresed in the same lane as a sample and can accurately predict the electrophoresis position of the sample.

Problems, configurations, and effects other than those described above will be clarified by the following description of embodiments.

### BRIEF DESCRIPTION OF DRAWINGS

FIG. 1 shows electrophoretic patterns of samples 1 to 4 obtained as a result of a DNA polymerase reaction of polyphosphoric acid.

FIG. 2 shows electrophoretic patterns of DNA samples A to D.

FIG. 3 is an image obtained when the agarose gel destained after staining was observed under white light.

FIG. 4 is a graph showing the fragment length distribution of a DNA sample.

FIG. 5 is a graph showing a fragment length distribution of extracted DNA fragments.

FIG. 6 is a graph showing a fragment length distribution of extracted DNA fragments.

### DESCRIPTION OF EMBODIMENTS

The present disclosure is not to be construed as being limited to the description of the following exemplary embodiments. Those skilled in the art can easily understand that the specific configuration can be changed without departing from the spirit or gist of the present disclosure.

Components expressed in the singular herein are intended to include the plural unless the context clearly dictates otherwise.

In the present disclosure, “nucleic acid” means DNA and RNA, and includes those derived from a biological sample and those artificially synthesized. In addition, the “nucleic acid” in the present disclosure also encompasses a single-stranded nucleic acid, a double-stranded nucleic acid, or other modified nucleic acids.

### First Embodiment

<Molecular Weight Marker for Electrophoresis>

A molecular weight marker (nucleic acid molecular weight marker reagent) for electrophoresis according to the first embodiment contains a polyelectrolyte which is negatively charged in an aqueous solution and does not serve as a template for a DNA polymerase reaction. That is, it is different in properties from nucleic acid samples (DNA, RNA). Here, “not serve as a template for a DNA polymerase reaction” means that when the DNA polymerase reaction is performed with the molecular weight marker for electrophoresis mixed in a sample, the amount of a DNA amplification product derived from the molecular weight marker for electrophoresis is less than 10 pg/μL (not 10 pg/μL or more). Incidentally, the reason why the value is set to “10 pg/μL” is that it is the detection limit of Qubit (registered trademark, manufactured by Thermo Fisher Scientific Inc.), which is generally used as a DNA quantification device.

The molecular weight marker for electrophoresis (hereinafter, it may be simply referred to as a “molecular weight marker”) may be a substance that does not inhibit the DNA polymerase reaction. Here, “does not inhibit the DNA polymerase reaction” means that when the DNA polymerase reaction is performed with the molecular weight marker for electrophoresis being mixed in a nucleic acid, the amplification amount of a nucleic acid is 95% or more as compared with that in a case without the molecular weight marker for electrophoresis being mixed therein.

In order for the polyelectrolyte to function as a molecular weight marker, the molecular weight of the polyelectrolyte is adjusted to such a molecular weight that it exhibits the same mobility as the mobility of a nucleic acid having a target base length. The molecular weight marker for electrophoresis may contain a plurality of polyelectrolytes having different molecular weights that respectively exhibit mobilities equal to those of nucleic acids having corresponding base lengths. In other words, they may be provided to users as a set of molecular weight markers for electrophoresis. Specifically, for example, polyelectrolytes having different molecular weights that exhibit mobilities equal to those of nucleic acids of 50 bp, 100 bp, 150 bp, 200 bp, and 1000 bp, respectively, may be contained. The intended combination of base lengths is not limited to the above, and any combination can be adopted.

Since the polyelectrolyte is negatively charged in an aqueous solution, it can be electrophoresed in the same direction as the nucleic acids. In addition, since the polyelectrolyte is a substance that does not serve as a template for a DNA polymerase reaction, the polyelectrolyte, even if being mixed with a nucleic acid collected after electrophoresis, exerts only small influence on the next step. Therefore, the polyelectrolyte can be electrophoresed in the same lane as a nucleic acid, and the molecular weight of the nucleic acid can be accurately estimated.

For forming a molecular weight marker for electrophoresis, a homopolymer can be used as the polyelectrolyte described above. Examples of the homopolymer that can be used as the molecular weight marker for electrophoresis of the present embodiment include a polyphosphoric acid, a polymeric carboxylic acid, a polymeric sulfonic acid, and salts or derivatives thereof. In addition, any substance exhibiting similar behavior as those of these substances can be similarly used.

Examples of the polymeric carboxylic acid include polyacrylic acid, carboxymethyl cellulose, poly(3-hydroxymethyl-hexamethylene-1,3,5-tricarboxylic acid), poly(4-methoxy-tetramethylene-1,2-dicarboxylic acid), and poly(tetramethylene-1,2-dicarboxylic acid). Examples of the polymeric sulfonic acid include polystyrene sulfonic acid and polyvinyl sulfonic acid.

Among the above homopolymers, in particular, the polyphosphoric acid has the same mobility as that of a DNA having a specific length regardless of the concentration of the electrophoresis gel, and thus the length of the DNA fragment can be accurately estimated when the polyphosphoric acid is used as a molecular weight marker. In addition, the production cost of polyphosphoric acid as a molecular weight marker is low since polyphosphoric acid can be used without special treatment, can be stained by many methods, and is inexpensive.

As a molecular weight marker for electrophoresis, a copolymer also can be used as the polyelectrolyte described above. Examples of the copolymer that can be used as the molecular weight marker for electrophoresis of the present embodiment include mucopolysaccharides, and salts or derivatives thereof. Examples of the mucopolysaccharide include hyaluronic acid, chondroitin sulfate, heparin, glycosaminoglycan, heparan sulfate, dermatan sulfate, keratan sulfate, keratan polysulfate, and chitin.

Examples of the salt of the polyelectrolyte include a sodium salt and a potassium salt, and can be a salt of a negatively charged polyelectrolyte and an arbitrary cation.

Among the above polyelectrolytes, a linear polyelectrolyte may be used, so that a molecular weight marker having an arbitrary mobility can be obtained simply by adjusting the number of polymerized monomers. Of course, the polyelectrolyte may be branched.

The molecular weight marker for electrophoresis may be provided in the form of an aqueous solution of a polyelectrolyte. The pH of the aqueous solution is not limited, but can be, for example, pH 2 or more from the viewpoint of preventing the degradation of the nucleic acid to be electrophoresed together.

The molecular weight marker for electrophoresis may contain substances other than the polyelectrolyte, such as a dye capable of staining the polyelectrolyte, a solvent such as water, a buffer, a specific gravity regulator, and salts.

<Method for Producing Molecular Weight Marker for Electrophoresis>

An example of a method for producing the molecular weight marker for electrophoresis of the present embodiment is described below. In the present production method, a plurality of polyelectrolytes having different molecular weights with unknown electrophoretic mobilities are used as materials.

A ladder marker containing a nucleic acid having a target base length as a molecular weight marker for electrophoresis according to the present embodiment is prepared. The ladder marker generally contains nucleic acids of a plurality of known base lengths.

An electrophoresis gel is set in an electrophoresis apparatus, a ladder marker and a plurality of polyelectrolytes having different molecular weights are injected into a slit of the electrophoresis gel, and electrophoresis is performed. The lane of the ladder marker and the lane of the polyelectrolyte are adjacent to each other. Here, the voltage and the voltage application time during electrophoresis can be appropriately set according to the concentration of the gel to be used, the type of the ladder marker, and the like.

The gel after electrophoresis is immersed in an aqueous solution of a nucleic acid staining dye to stain the nucleic acids of the ladder marker. Thereby, the electrophoretic mobility of the nucleic acid of each base length in the ladder marker can be visually recognized as a band.

Next, portions of the gel at the same position as the bands of the ladder marker are cut out from the lane of the polyelectrolyte. Next, the polyelectrolyte is precipitated by, for example, ethanol precipitation and is collected, and an aqueous solution of the collected polyelectrolyte is obtained and used as a molecular weight marker. Here, by mixing DNA having a target base length with an aqueous solution of a polyelectrolyte (for example, a part thereof) and performing gel electrophoresis, it is confirmed that the mobility of the DNA having the target base length is the same as the mobility of the polyelectrolyte. In preparation of the aqueous solution of the polyelectrolyte, a single aqueous solution may contain polymer electrolytes collected from positions of a plurality of bands collectively, or a single aqueous solution may contain one polyelectrolyte collected from a position of one band. That is, the molecular weight marker may be a molecular weight marker containing a set of polyelectrolytes having a plurality of chain lengths corresponding to a plurality of bands, or may be a molecular weight marker containing only a polyelectrolyte having a chain length corresponding to a certain band.

The method for producing a molecular weight marker for electrophoresis is not limited to the above method, and other methods can also be employed. For example, mass production can also be performed by measuring the molecular weight of the polyelectrolyte having the same mobility as that of the nucleic acid having a specific base length obtained as described above, and synthesizing a polyelectrolyte having this molecular weight.

### Technical Effects

As described above, a molecular weight marker for electrophoresis according to the first embodiment contains a polyelectrolyte which is negatively charged in an aqueous solution and does not serve as a template for a DNA polymerase reaction. As a result, the marker can be electrophoresed in the same lane as that of a nucleic acid sample, so that the electrophoresis position of the nucleic acid can be accurately estimated. That is, the nucleic acid sample can be accurately fractionated for each target base length. In addition, since it is not necessary to use a lane for a molecular weight marker, analysis throughput can be improved.

### Second Embodiment

<Molecular Weight Marker for Electrophoresis>

A molecular weight marker for electrophoresis (nucleic acid molecular weight marker reagent) according to the second embodiment contains a polyelectrolyte that is one or more of polyphosphoric acids, polymeric carboxylic acids, polymeric sulfonic acids, anion exchange resins, mucopolysaccharides, and salts or derivatives thereof.

Examples of the polymeric carboxylic acid include polyacrylic acid, carboxymethyl cellulose, poly(3-hydroxymethyl-hexamethylene-1,3,5-tricarboxylic acid), poly(4-methoxy-tetramethylene-1,2-dicarboxylic acid), and poly(tetramethylene-1,2-dicarboxylic acid). Examples of the polymeric sulfonic acid include polystyrene sulfonic acid and polyvinyl sulfonic acid. Examples of the anion exchange resin include cholestyramine. Examples of the mucopolysaccharide include hyaluronic acid, chondroitin sulfate, heparin, glycosaminoglycan, heparan sulfate, dermatan sulfate, keratan sulfate, keratan polysulfate, and chitin.

In order for the polyelectrolyte to function as a molecular weight marker, the molecular weight of the polyelectrolyte listed above is adjusted to such a molecular weight that it exhibits the same mobility as the mobility of a nucleic acid having a target base length.

In addition, any of these polyelectrolytes do not serve as templates for DNA polymerase reactions. The polyelectrolyte, therefore, even if being mixed with a nucleic acid collected after electrophoresis, exerts only small influence on the next step. Therefore, the polyelectrolyte can be electrophoresed in the same lane as a nucleic acid sample, and the molecular weight of the nucleic acid can be accurately estimated.

Since the other features of the molecular weight marker for electrophoresis according to the present embodiment are similar to those of the first embodiment, the description thereof is omitted.

### Third Embodiment

In the third embodiment, a method for size fractionation of a nucleic acid sample containing nucleic acid fragments of various base lengths using the above-described molecular weight marker for electrophoresis is described. The method for size fractionation of a nucleic acid according to the present embodiment can mainly adopt general methods, but is characterized in that the above-described molecular weight marker for electrophoresis and a nucleic acid sample to be fractionated are electrophoresed in the same lane.

First, a nucleic acid sample to be fractionated is mixed with a molecular weight marker for electrophoresis containing a polyelectrolyte having a chain length corresponding to a base length of a target nucleic acid fragment to be collected.

Next, a mixture of the nucleic acid sample and the molecular weight marker for electrophoresis is injected into the gel electrophoresis apparatus. As a method of electrophoresis, general methods can be adopted, and therefore it will not be particularly described here. The nucleic acid sample to be fractionated and the molecular weight marker for electrophoresis may be injected into a slit of the same lane of the electrophoresis gel without being mixed in advance.

Next, the gel after electrophoresis is stained using a dye capable of staining the polyelectrolyte. Thereby, the position of the band of the molecular weight marker is visualized. A portion of the gel is cut out from the position of the band of the stained polyelectrolyte, and a nucleic acid fragment is extracted from each portion of the gel thus cut out.

The nucleic acid fractionation method of the present embodiment is not limited to the following, but can be performed, for example, at a pretreatment stage of analysis by a next generation DNA sequencer.

As described above, a nucleic acid fractionation method of the present embodiment includes the steps of: preparing a molecular weight marker for electrophoresis containing a polyelectrolyte that is negatively charged in an aqueous solution and does not serve as a template for a DNA polymerase reaction; electrophoresing a molecular weight marker for electrophoresis and a nucleic acid sample in the same lane; and acquiring a nucleic acid fragment of a target base length, based on an electrophoresis position of the molecular weight marker for electrophoresis. This makes it possible to accurately fractionate a nucleic acid fragment having a target base length from a nucleic acid sample.

### Fourth Embodiment

In the fourth embodiment, a method for analyzing a size of a nucleic acid using the above-described molecular weight marker for electrophoresis is described. A procedure of the nucleic acid size analysis method according to the present embodiment is substantially similar to that of the nucleic acid fractionation method described in the third embodiment. That is, the base length of the nucleic acid fragment contained in the nucleic acid sample can be estimated by mixing the molecular weight marker for electrophoresis containing polyelectrolytes having a plurality of chain lengths corresponding to a plurality of base lengths with the nucleic acid sample to be analyzed for size, and performing electrophoresis.

As described above, a nucleic acid size analysis method of the present embodiment includes the steps of: preparing a molecular weight marker for electrophoresis containing a polyelectrolyte that is negatively charged in an aqueous solution and does not serve as a template for a DNA polymerase reaction; electrophoresing the molecular weight marker for electrophoresis and the nucleic acid in the same lane; and estimating a base length of a nucleic acid fragment contained in the nucleic acid, based on an electrophoresis position of the molecular weight marker for electrophoresis. This makes it possible to accurately estimate a base length of a fragment contained in a nucleic acid sample.

### EXAMPLES

Hereinafter, examples of the present disclosure are described, but the examples are merely exemplary and do not limit the technical scope of the present disclosure.

<Production of Molecular Weight Marker for Electrophoresis>

Molecular weight markers for electrophoresis of polyphosphoric acid having mobilities equal to that of a 200 bp DNA and that of a 300 bp DNA, respectively, were prepared by the following procedure.

First, a commercially available extremely-long-chain polyphosphoric acid solution (manufactured by Bioenex Inc.) was prepared. This extremely-long-chain polyphosphoric acid solution contains polyphosphoric acid having a chain length of about 200 to 1000 base pairs, and typically has a concentration of 100 mg/mL. These extremely-long-chain polyphosphoric acids having such a plurality of molecular weights, respectively, and a DNA ladder marker whose mobility is known, are subjected to agarose gel electrophoresis, and portions of the gel at the same positions as the respective positions of the bands of the DNA ladder marker are cut out from the lane of the extremely-long-chain polyphosphoric acid, whereby the polyphosphoric acid having a chain length corresponding to a target base length as a DNA molecular weight marker can be obtained.

The agarose gel was prepared by pouring 3% SeaKem (registered trademark) GTG-TAE (manufactured by Lonza KK.) into a plastic container and molding it. A slit into which a sample and a molecular weight marker are injected was provided in an upper portion of the agarose gel. The prepared agarose gel was horizontally placed on an electrophoresis apparatus (trade name: Mupid (registered trademark), manufactured by Mupid Co., Ltd.), and the electrophoresis tank was filled with 1×TAE buffer (tris-acetate EDTA Buffer).

A sample was prepared by mixing 1 μL of an extremely-long-chain polyphosphoric acid with 1 μL of 6×DNA Loading Dye (manufactured by Thermo Fisher Scientific Inc.). The sample and a commercially available DNA ladder marker (trade name: 1 kb plus DNA Ladder, manufactured by Thermo Fisher Scientific Inc.) for confirming the electrophoresis position of DNA were each injected into the slit of the agarose gel, and electrophoresed at 100 V for 30 minutes.

Thereafter, the agarose gel was immersed in a 10,000-fold diluted aqueous solution of SYBR Green I so that the nucleic acids were stained.

Based on the positions of the bands of the DNA ladder marker, a portion of the gel at the same position as the 200 bp DNA was cut out from the lane of the extremely-long-chain polyphosphoric acid. Thereafter, ethanol precipitation was performed to collect polyphosphoric acid, and then, 20 μL of a 1 mg/mL polyphosphoric acid aqueous solution was obtained. A 200 bp DNA prepared in advance by PCR amplification was mixed with this polyphosphoric acid aqueous solution, and gel electrophoresis was performed using an agarose gel prepared in the same procedure as described above. As a result, it was confirmed that the mobility of the polyphosphoric acid was the same as the mobility of 200 bp DNA. A portion of the gel at the same position as the 300 bp DNA was also subjected to the same procedure, whereby 20 μL of a 1 mg/mL polyphosphoric acid aqueous solution as to this portion was obtained. Thereafter, a 300 bp DNA prepared in advance by PCR amplification was mixed therewith, and the obtained mixture was subjected to gel electrophoresis. It was confirmed that the mobility of polyphosphoric acid was the same as the mobility of the 300 bp DNA. Therefore, these polyphosphoric acid aqueous solutions can be used as a 200 bp DNA molecular weight marker and a 300 bp DNA molecular weight marker, respectively.

<DNA Polymerase Reaction Using Polyphosphoric Acid>

By the following procedure, it was confirmed that the polyphosphoric acid does not serve as a template for a DNA polymerase reaction. Specifically, PCR amplification was performed, using Takara Ex Taq (manufactured by Takara Bio Inc.), without a DNA template, and with 0.5 ng, 5 ng, or 50 ng of polyphosphoric acid being mixed, to prepare four samples 1 to 4. The obtained samples 1 to 4 was subjected to gel electrophoresis to confirm DNA amplification products.

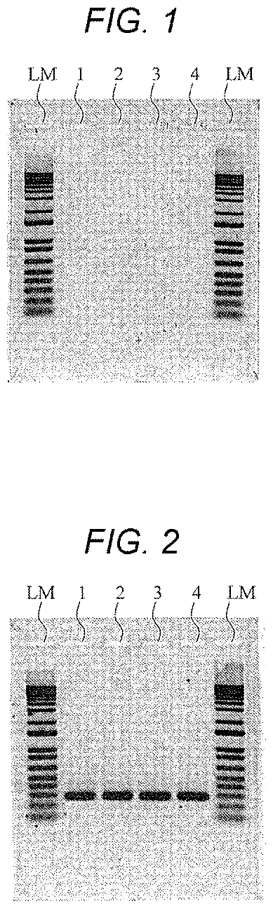

FIG. 1 shows electrophoretic patterns of samples 1 to 4 obtained as a result of a DNA polymerase reaction of polyphosphoric acid. In FIG. 1, two lanes LM are lanes in which a commercially available DNA ladder marker (product name: 1 kb Plus DNA Ladder, manufactured by Thermo Fisher Scientific Inc.) was electrophoresed. Lane 1 is a lane in which the sample 1 without no electrophoresis sample was electrophoresed, and Lanes 2 to 4 are lanes in which the samples 2 to 4 obtained by mixing 0.5 ng, 5 ng, or 50 ng of polyphosphoric acid, respectively, and causing a reaction was electrophoresed. As shown in FIG. 1, no DNA band was observed in any of Lanes 1 to 4.

Next, DNAs contained in the samples 1 to 4 were quantified using a DNA quantification device (trade name: Qubit (registered trademark), manufactured by Thermo Fisher Scientific Inc.), and were found to be all less than 10 pg/μL. Based on the above-described results, it was confirmed that the polyphosphoric acid does not serve as a template for a DNA polymerase reaction.

<Verification of Inhibition of DNA Polymerase Reaction by Polyphosphoric Acid>

By the following procedure, it was confirmed that the polyphosphoric acid does not inhibit a DNA polymerase reaction. Specifically, PCR amplification was performed, using Takara Ex Taq (manufactured by Takara Bio Inc.), with use of DNA of λ phage as a template, and without polyphosphoric acid being mixed, to prepare a DNA sample A. In addition, 0.5 ng, 5 ng, or 50 ng of polyphosphoric acid was mixed in the DNA templates, respectively, and were subjected to PCR amplification, to prepare DNA samples B to D, respectively. The obtained DNA samples A to D was subjected to gel electrophoresis to confirm DNA amplification products.

FIG. 2 shows electrophoretic patterns of the DNA samples A to D. In FIG. 2, two lanes LM are lanes in which a DNA ladder marker (product name: 1 kb Plus DNA Ladder, manufactured by Thermo Fisher Scientific Inc.) was electrophoresed. Lane 1 is a lane in which the DNA sample A obtained by PCR amplification of a DNA template without polyphosphoric acid was electrophoresed. Lanes 2 to 4 are lanes in which DNA samples B to D, obtained by mixing 0.5 ng, 5 ng, or 50 ng of polyphosphoric acid in the DNA templates, respectively, and subjecting the same to PCR amplification, were electrophoresed. As shown in FIG. 2, DNA bands were observed in all of Lanes 1 to 4.

Next, DNAs contained in the DNA samples A to D were quantified using a DNA quantification device (Qubit). In the cases of DNA samples B to D, the amplification amount was 95% or more as compared with the amplification amount in the case of the DNA sample A (without polyphosphoric acid). Based on the above-described results, it was confirmed that the polyphosphoric acid does not inhibit a DNA polymerase reaction.

<Collection of DNA Fragments Using Molecular Weight Marker for Electrophoresis of Polyphosphoric Acid>

A DNA sample containing fragments of 50 bp to 1500 bp was subjected to agarose gel electrophoresis using the molecular weight marker of polyphosphoric acid corresponding to 200 bp and a molecular weight marker of polyphosphoric acid corresponding to 300 bp, prepared as described above, and 200 bp DNA fragments and 300 bp DNA fragments were collected. Specifically, DNA fragments of each type were collected by the following procedure.

The agarose gel was prepared by pouring 3% SeaKem (registered trademark) GTG-TAE (manufactured by Lonza KK.) into a plastic container and molding it. A slit into which a sample and a molecular weight marker are injected was provided in an upper portion of the agarose gel. The prepared agarose gel was horizontally placed on an electrophoresis apparatus (trade name: Mupid (registered trademark), manufactured by Mupid Co., Ltd.), and the electrophoresis tank was filled with 1×TAE buffer (tris-acetate EDTA Buffer).

A mixed solution was obtained by mixing 1 μL of the DNA sample (500 ng/μL) with 1 μL of 6×DNA Loading Dye (manufactured by Thermo Fisher Scientific Inc.) and 1 μL of the molecular weight marker of polyphosphoric acid for electrophoresis corresponding to 200 bp (1 mg/mL). For the molecular weight marker of polyphosphoric acid corresponding to 300 bp as well, a mixed solution was obtained in the same manner. These mixed solutions were injected into the slit of the agarose gel and electrophoresed at 100 V for 30 minutes.

After electrophoresis, the agarose gel was immersed in 0.5% toluidine blue aqueous solution for 20 minutes for staining, and then destained using Milli-Q water (“Milli-Q” is a registered trademark) for 2 hours.

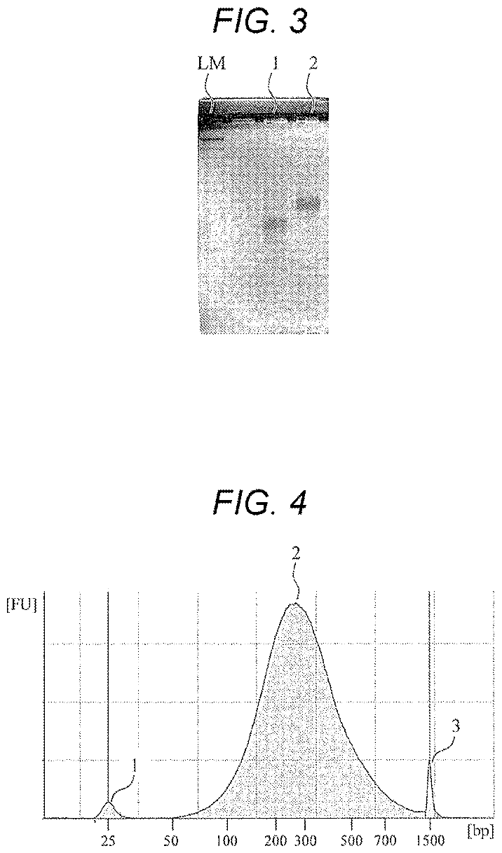

FIG. 3 is an image obtained when the agarose gel destained after staining was observed under white light. In FIG. 3, a lane LM is a lane in which a DNA ladder marker (product name: 1 kb Plus DNA Ladder, manufactured by Thermo Fisher Scientific Inc.) was electrophoresed. Lane 1 is a lane in which the sample mixed with polyphosphoric acid corresponding to 200 bp was electrophoresed, and lane 2 is a lane in which the sample mixed with polyphosphoric acid corresponding to 300 bp was electrophoresed. Incidentally, bands of the lanes 1 and 2 are those of stained polyphosphoric acid.

Next, portions of the gel at the same positions as the respective positions of the bands of the molecular weight marker of polyphosphoric acid were cut out, and DNA fragments were extracted from the respective portions of the gel using NucleoSpin (registered trademark) Gel and PCR kit (manufactured by Takara Bio Inc.). Hereinafter, the DNA fragments acquired from the position of the band of lane 1 is referred to as “DNA fragment 200”, and the DNA fragment acquired from the position of the band of lane 2 is referred to as “DNA fragment 300”.

Finally, respective length distributions of the extracted DNA fragments 200 and 300, as well as the DNA fragments contained in the original DNA sample were determined using the Tape Station (manufactured by Agilent Technologies Inc.), which is a DNA qualitative device. The results are shown in FIGS. 4 to 6.

FIG. 4 is a graph showing the fragment length distribution of a DNA sample containing fragments of 50 bp to 1500 bp. In FIG. 4, the horizontal axis represents base length [bp], and the vertical axis represents fluorescence intensity [FU]. Peak 1 indicates the peak of a lower marker for analysis, and Peak 3 indicates the peak of an upper marker for analysis. Peak 2 indicates the peak of the DNA sample. As shown in FIG. 4, it was confirmed that the DNA sample contained DNA fragments of 50 bp to 1500 bp.

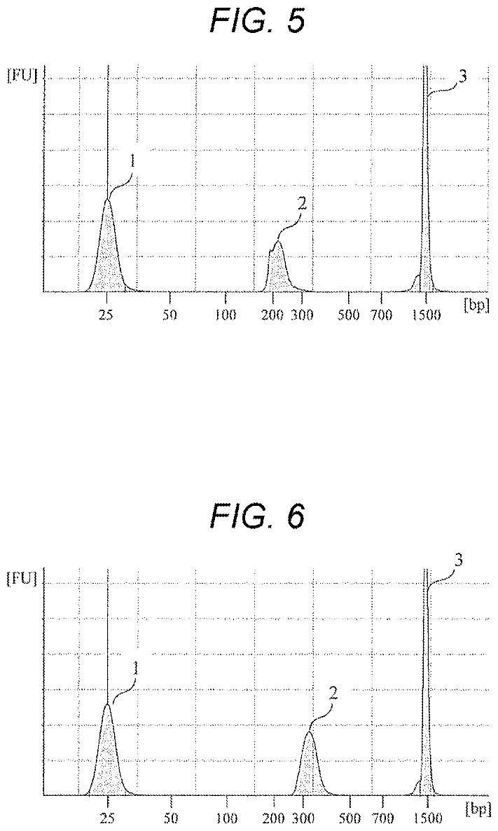

FIG. 5 is a graph showing the fragment length distribution of the extracted DNA fragments 200. Peaks 1 and 3 are the same as those in FIG. 4. In FIG. 4, the peak ranging from 50 bp to 1500 bp appears, whereas in FIG. 5, the narrow peak 2 appears at 200 bp. This proves that the 200 bp DNA fragment could be collected by using a molecular weight marker of polyphosphoric acid showing a mobility corresponding to 200 bp.

FIG. 6 is a graph showing the fragment length distribution of the extracted DNA fragment 300. Peaks 1 and 3 are the same as those in FIG. 4. In FIG. 4, the peak ranging from 50 bp to 1500 bp appears, whereas in FIG. 6, the narrow peak 2 appears at 300 bp. This proves that the 300 bp DNA fragment could be collected by using a molecular weight marker of polyphosphoric acid showing a mobility corresponding to 300 bp.

As described above, by using the molecular weight marker of polyphosphoric acid, a nucleic acid fragment having a target base length can be accurately obtained.

1. A molecular weight marker for electrophoresis containing a polyelectrolyte that is negatively charged in an aqueous solution and does not serve as a template for a DNA polymerase reaction.

2. The molecular weight marker for electrophoresis according to claim 1, wherein the polyelectrolyte is a linear polyelectrolyte.

3. The molecular weight marker for electrophoresis according to claim 1, wherein the polyelectrolyte a homopolymer polyelectrolyte.

4. The molecular weight marker for electrophoresis according to claim 1, wherein the polyelectrolyte is a copolymer polyelectrolyte.

5. The molecular weight marker for electrophoresis according to claim 1, wherein the polyelectrolyte is a polyelectrolyte that is one or more of polyphosphoric acids, polymeric carboxylic acids, polymeric sulfonic acids, anion exchange resins, mucopolysaccharides, and salts or derivatives thereof.

6. A nucleic acid fractionation method for size fractionation of a nucleic acid by electrophoresis, the method comprising the steps of:
preparing a molecular weight marker for electrophoresis containing a polyelectrolyte that is negatively charged in an aqueous solution and does not serve as a template for a DNA polymerase reaction;
electrophoresing the molecular weight marker for electrophoresis and the nucleic acid in a same lane; and
acquiring a nucleic acid of a target base length, based on an electrophoresis position of the molecular weight marker for electrophoresis.

7. The nucleic acid fractionation method according to claim 6, wherein the polyelectrolyte is a linear polyelectrolyte.

8. The nucleic acid fractionation method according to claim 6, wherein the polyelectrolyte.

9. The nucleic acid fractionation method according to claim 6, wherein the polyelectrolyte is a copolymer polyelectrolyte.

10. The nucleic acid fractionation method according to claim 6, wherein the polyelectrolyte is a polyelectrolyte that is one or more of polyphosphoric acids, polymeric carboxylic acids, polymeric sulfonic acids, anion exchange resins, mucopolysaccharides, and salts or derivatives thereof.

11. A nucleic acid size analysis method for analyzing a size of a nucleic acid by electrophoresis, the method comprising the steps of:
preparing a molecular weight marker for electrophoresis containing a polyelectrolyte that is negatively charged in an aqueous solution and does not serve as a template for a DNA polymerase reaction;
electrophoresing the molecular weight marker for electrophoresis and the nucleic acid in a same lane; and
estimating a base length of a nucleic acid fragment contained in the nucleic acid, based on an electrophoresis position of the molecular weight marker for electrophoresis.

12. The nucleic acid size analysis method according to claim 11, wherein the polyelectrolyte is a linear polyelectrolyte.

13. The nucleic acid size analysis method according to claim 11, wherein the polyelectrolyte is homopolymer polyelectrolyte.

14. The nucleic acid size analysis method according to claim 11, wherein the polyelectrolyte is a copolymer polyelectrolyte.

15. The nucleic acid size analysis method according to claim 11, wherein the polyelectrolyte is a polyelectrolyte that is one or more of polyphosphoric acids, polymeric carboxylic acids, polymeric sulfonic acids, anion exchange resins, mucopolysaccharides, and salts or derivatives thereof.
